(19) United States
(12) Patent Application Publication
(10) Pub. No.: US 2005/0016952 A1
(43) Pub. Date: Jan. 27, 2005

(54) SYSTEM AND METHOD OF ALTERING A VERY SMALL SURFACE AREA BY MULTIPLE CHANNEL PROBE

(75) Inventors: Hendrik F. Hamann, Yorktown Heights, NY (US); Steven Brett Herschbein, Hopewell Junction, NY (US); Herschel Maclyn Marchman, Poughquag, NY (US); Chad Rue, Poughkeepsie, NY (US); Michael Ray Sievers, Poughkeepsie, NY (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 10/604,486

(22) Filed: Jul. 25, 2003

(51) Int. Cl. C23F 1/00; B44C 1/22; C03C 15/00; C03C 25/68

(52) U.S. Cl. 216/57

(57) ABSTRACT

A system and method are provided for altering a very small surface area of a feature of a substrate. The disclosed system includes a localized chemical delivery probe (LCDP) having a plurality of channels, in which each channel is adapted to carry a material through the probe to exit at an apex of the probe. The system further includes a way to maneuver the apex of the probe to a site proximate to the target feature on the surface. A first channel of the probe is preferably coupled to a source of chemical to assist in a reaction, and a second channel of the probe is preferably coupled to a second chemical, a diluting fluid, an expulsion gas, and/or suction to provide the same through the probe apex. In a preferred embodiment, a first chemical is delivered by a first channel of the probe to assist in an exothermic reaction to etch a low-K organic dielectric, and a diluting fluid or suction is provided by a second channel to confine the effect of the reaction.

### CROSS REFERENCE TO RELATED APPLICATIONS

The following applications (International Business Machines Corporation) are related to the present application: U.S. patent application Ser. No. 10/261,275, filed Sep. 30, 2002, titled “Tool Having a Plurality of Electrodes and Corresponding Method of Altering a Very Small Surface,” and Attorney Docket No. FIS920020166US1 entitled: “Systems and Methods of Altering a Very Small Surface Area.” The disclosures of these applications are incorporated herein by reference.

### BACKGROUND OF INVENTION

The present invention relates to the altering of very small (e.g. micron-scale and nanometer-scale) surface areas, and more specifically to a method and corresponding system for altering a very small surface area using a probe having a plurality of channels, at least one of which locally supplies a chemical to the surface to be altered.

Current repair processes for integrated circuit (IC) chips and lithographic reticles rely primarily on the use of focused beams (ion, electron, and/or photons) to induce localized reactions for etching or deposition of materials for when editing patterns. Focused Ion Beam (FIB) tools have played a dominant role for most repair applications as well as in failure analysis methods, due to their superior spatial process confinement and reaction rates (relative to scanning electron or photon beams). However, concerns about ion beam induced damage and contamination have severely limited the applicability of FIB tools inside IC clean rooms and lithographic mask production facilities. The more recent use of copper metallization and low-K dielectric (polymer) materials in IC fabrication has raised concerns about the extendibility of FIB tools for these applications.

FIG. 1 illustrates such example, which is background to the invention, but is not admitted to be prior art. As shown in FIG. 1, a copper feature 10 of a substrate 20 lies under a plurality of layers 12 of inter-level dielectric (ILD) material. Specifically, the editing (i.e. cutting) of lower level metallization copper IC features 10 by FIB tools has proved troublesome due to the tendency of the copper milled by the tool to be redeposited on surfaces 14 of the entry hole 16 made by the tool (FIG. 1). Regions 11 where the copper remains or is redeposited are conductive and thus, the desired degree of electrical isolation (i.e. the reason for cutting the line) is not achieved. In addition, when ILD 12 is a low-K polymer, it becomes may become conductive in places 14 which are exposed to the ion beam 15.

In addition, changes in the optical properties of lithographic masks, known as staining, caused by gallium ions (the source of ions in FIB tools is Ga+) and edge streaking (river-bedding) are examples of problems being encountered with FIB-based mask repair. Thus, a critical need exists for a new tool and method for the working of micro-scale surfaces, for example, for the repair of IC's and masks. At the same time, the failure of existing in-line metrology techniques to provide accurate three dimensional data for the development and control of IC fabrication processes has highlighted the need for a tool capable of sectioning a surface without causing damage or contamination (Ga+ is a metal) to either the surface or to clean room equipment and materials.

FIB-based repair and metrology also suffers from incompatibility of FIB legacy processes with new materials for IC fabrication: a) Undesired re-deposition of conductive byproducts; b) Induced surface conductivity of organic interlevel dielectric layers (ILDs). FIB-based repair and metrology provides only limited lateral confinement of processes and reaction products, and endpointing of the processes is difficult or manual. FIB-based processes have limited throughput due to difficulty in navigating to feature of interest. FIB tools are also relatively complex and expense.

Thus, a need exists for a system and method for altering a very small surface area of a feature of a substrate, which provides good spatial process confinement, but without some of the problems and/or complexity of a FIB-based tool.

### SUMMARY OF INVENTION

The invention provides systems and methods for altering a very small surface area, for example, for the repair of integrated circuits or photomasks. The systems and methods of the invention are characterized by the use of multiple channel probes (i.e., channels for delivery of chemicals and/or asserting action (e.g., suction) at a highly localized site at the apex of the probe.

In one aspect, the invention encompasses a system adapted to alter a feature of a substrate, the system comprising: (a) a probe having a plurality of channels each being through the probe to exit at an apex of the probe, (b) means for maneuvering the apex of the probe to a site proximate to a target feature to be altered, (c) a source of a first chemical coupled to a first channel of the probe for delivery of the first chemical through the apex, and (d) a source of at least one of a second chemical, a diluting fluid, an expulsion gas, and suction, coupled to a second channel for delivery though the apex. The system may include additional components such as sources of illumination or other energy to be delivered to the site of the target feature. The apex of the probe preferably has a diameter of about 3 microns to 0.01 microns.

In another aspect, the invention encompasses a method of altering a feature of a substrate, the method comprising: (a) delivering a chemical for assisting in a reaction to a site proximate to a target feature to be altered through a channel of a probe, the channel having an exit at an apex of the probe; and (b) providing at least one of a second chemical, a diluting fluid, an expulsion gas, and suction to the site through a second channel of the probe, wherein the second chemical, the diluting fluid, and/or the suction aids in at least one of promoting and/or managing the reaction at the site. The site is preferably about 3 microns to 0.01 microns. In a preferred embodiment, the first chemical is delivered by the probe assists in an exothermic reaction to etch an organic low-K dielectric, and a second channel of the probe provides a diluting fluid or suction to confine an effect of the reaction.

The system and method of the invention are preferably applied to the repair and/or metrology of very small features of densely patterned substrates, e.g., an integrated circuit, an electronic package, or a photomask.

These and other aspects of the invention are described in further detail below.

### BRIEF DESCRIPTION OF DRAWINGS

FIG. 1 illustrates a background method of etching a substrate using a focused ion beam (FIB) tool.

FIGS. 2 and 3 illustrate embodiments of multiple channel probes, such as may be used in embodiments of the invention.

FIG. 4 illustrates a system embodiment of the invention.

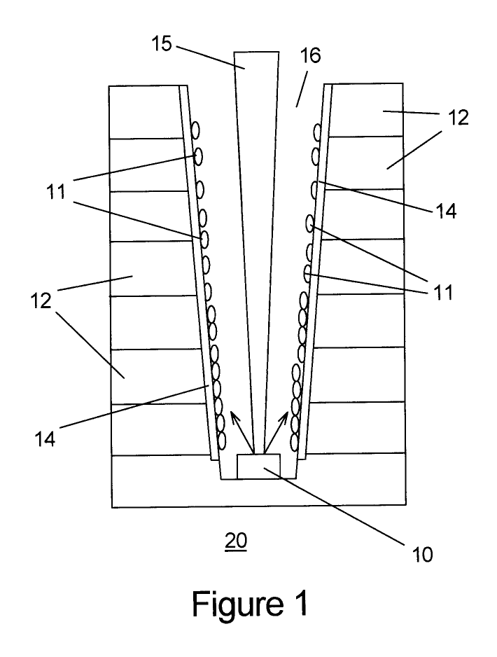

### DETAILED DESCRIPTION

The invention provides systems and methods for altering a very small surface area, for example, for the repair of integrated circuits or photomasks. The systems and methods of the invention are characterized by the use of multiple channel probes, i.e., channels for delivery of chemicals (e.g., a reactive chemical or diluting fluid) and/or asserting action (e.g., an expulsion gas or suction) at a highly localized site at the apex of the probe.

Localized chemical delivery probes (LCDPs) of the invention have multiple hollow channels which can be configured together in one probe. The multiple channels can enable the ability to mix different chemicals directly at the site of interest, to dilute resulting reaction products (localized rinse), to clean up the site using gas expulsion and/or suction, and/or to perform other tasks or variations on methods.

In such LCDPs, a chemical is delivered to a reaction site through an aperture in the apex of a probe. Spatial confinement of the chemical delivery is controlled, at least in part, by the size of the aperture. In some applications, the chemical channel and aperture are sufficiently small to prevent liquid from flowing out, due to capillary forces and surface tension, until it is brought onto the surface. Upon approach or contact, the chemical is drawn out of the probe by atomic force interaction only to an area of sample surface about equal to the aperture size. Control of the pressure of the chemical provided to the channel or of the ambient can also affect the amount of chemical delivered to the reaction site. Since the probe is brought into contact or close proximity with the surface, mechanically assisted removal of products is also possible. Probe-based mechanical assisted material removal is analogous to the sputter mill component of FIB GAE processes and can help increase anisotropy (aspect ratio) or reaction rate in a similar fashion.

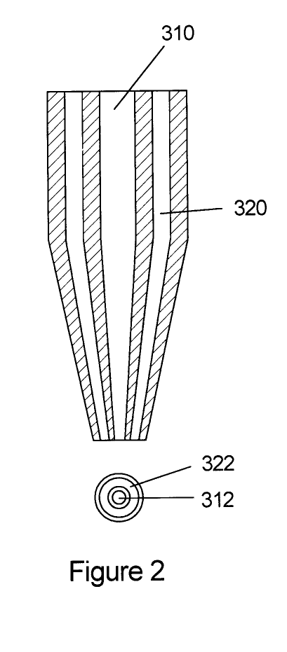

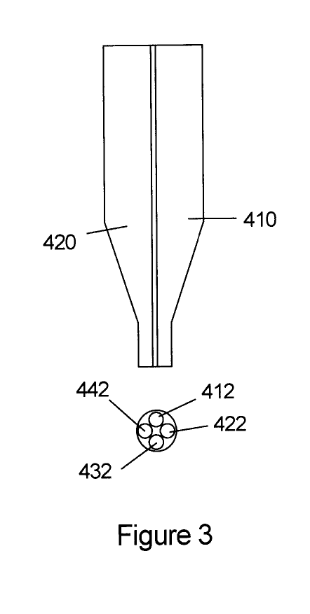

FIGS. 2 and 3 illustrate respective configurations of concentric channel probes (FIG. 2) and close-packed channel probes (FIG. 3). A concentric-channel probe preferably includes a hollow channel 310 of circular cross-section, surrounded by one or more additional hollow channels 320, of annular cross-section, the annular hollow channel(s) 320 being concentric with channel 310. Channel 310 terminates in a very small aperture 312, i.e., an aperture diameter of about 3 microns to about 10 nm or even smaller. As illustrated in FIG. 3, a close-packed channel probe preferably includes two or more hollow channels 410, 420 which are arranged in the same probe such that the channels terminate in apertures 412, 422 in very close proximity to each other, i.e., the closeness being comparable to the diameter of the aperture 412 (about 3 microns to about 10 nm or even smaller).

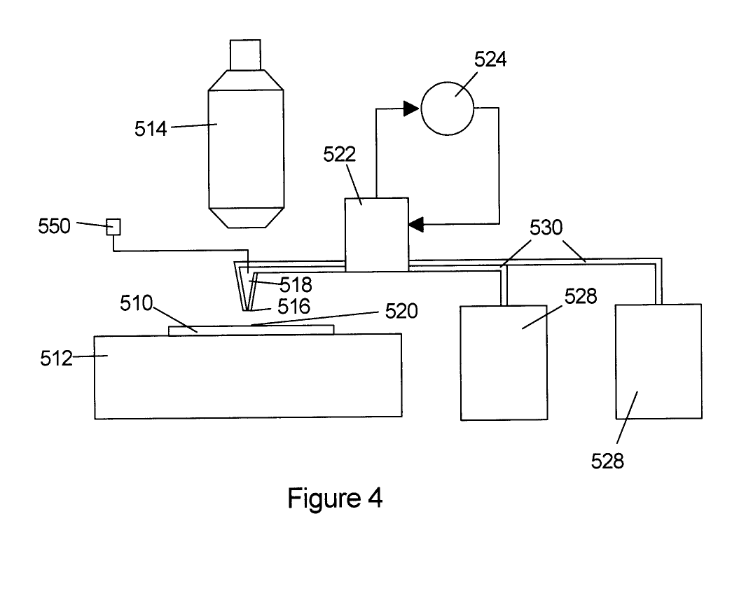

FIG. 4 illustrates a preferred embodiment of a system for altering a very small (e.g. micron-scale, nanometer-scale) surface area of a substrate for editing and/or repair of ICs and photomasks. The probes of the invention can be moved into close proximity to the site proximate to the target feature using apparatus that is available currently for the positioning of a scanned probe microscope (SPM). A substrate 510 to be worked rests on a movable stage 512 for initial coarse positioning of the substrate 510 and optical navigation under a high-NA (numerical aperture) objective lens microscope 514 to the site proximate to the target feature to be altered. High NA optical microscope viewing/imaging allows one to see where the apex 516 of probe 518 is relative to the feature of interest on the substrate, even if the feature of interest is below the top surface 520 of the substrate 510 (in cases when the substrate includes one or more optically transparent layers above the feature of interest).

In a preferred embodiment, an illuminating source 540, having one or more wavelengths selected from range consisting of the infrared to the ultraviolet, may be coupled to a light guide to a light guiding portion of the probe 518, such as to serve as a source of energy input to a reaction for altering the feature of interest on the substrate 510. The light guiding portion of the probe (which may comprise transparent sidewalls of a chemical delivery channel of the probe) may either end in the apex through which the light eventually exits, or alternatively, in a subwavelength, near field optical aperture. The illuminating source 540 may include ultraviolet wavelengths, if a highly spatially confined, high energy input is desired.

Preferably, the separation between the apex 516 and the surface to be worked are then actively regulated via surface force feedback (from transducer 522) and control electronics 524, as shown in FIG. 4. A reservoir source of chemical 528 is coupled through one or more ducts 530 for supplying the chemical to the surface to be worked on the substrate 510. Duct(s) 530 is coupled to deliver the chemical to a channel of probe 518, such that the location of chemical delivery to the substrate 510 is controlled in connection with the above-described method for positioning the probe apex 516 in proximity to the surface to be worked. In addition thereto, one or more additional chemicals for promoting, assisting or managing effects of the reaction can be supplied to the substrate as an ambient, or by flow directed towards the desired reaction site.

In a preferred embodiment, a system (FIG. 4) may be adapted for a particular application, such as the repair of a copper feature which may be buried beneath one or more layers of inter-level dielectric (ILD) on an IC. In such case, the system preferably includes a more than one probe tool, a first probe tool 518 having an apex 516 adapted specifically to etching the ILD above the copper feature, while a second probe tool 518 having an apex 516 is adapted specifically to editing the copper feature. Alternatively, the system may have one probe tool 518 which is used differently according to whether a relatively less confined etch of the ILD is to be done or a more confined editing of the copper feature is to be done.

In the case of multiple probe tools, the first probe tool can selectively etch the ILD leaving existing metal patterns, the etch reaction being promoted over a somewhat larger area of the IC than area for the subsequent copper edit reaction, e.g., from 5 to 50 times larger in diameter. The wider ILD etch can be accomplished by delivery of a relatively large volume of chemical and relying primarily on energy provided an energy source such as by source 540 (far-field illumination) to promote the necessary reaction. Alternatively, if probe 518 includes a near-field aperture, a near-field energy source can be used to control the ILD etch where the probe 518 could be scanned over the desired reaction site until the ILD etch is completed over the desired area.

The invention encompasses a method of altering a feature of a substrate, the method comprising: (a) delivering a chemical for assisting in a reaction to a site proximate to a target feature to be altered through a channel of a probe, the channel having an exit at an apex of the probe; and (b) providing at least one of a second chemical, a diluting fluid, an expulsion gas, and suction to the site through a second channel of the probe, wherein the second chemical, diluting fluid, expulsion gas, and/or suction aids in at least one of promoting and/or managing the reaction at the site. The site is preferably about 3 microns to 0.1 microns, or less in diameter. In a preferred embodiment, the first chemical is delivered by the probe assists in an exothermic reaction to etch a low-K organic dielectric, and a second channel of the probe provides a diluting fluid or suction to confine an effect of the reaction.

In one embodiment, a chip repair/circuit edit method can include steps as follows: (a) optically navigate to the specific site of interest (e.g., within half-micron resolution), (b) obtain more exact registration of the feature by probe fine scanning and imaging (Angstrom-scale resolution), (c) approach the surface with the probe tip and lock into position (d) edit surface or create access hole to level where feature resides, (e) optionally, for multi-step process prior to edit, if appropriate, locally oxidize a feature once it is uncovered, (f) real-time monitoring and/or imaging of surface height (spectroscopy or electrical measurement with probe also possible) to end-point control process, (g) flush-out, clean, and evacuate reaction products via extra probe channels or with adjacent nozzle or a rough vacuum environmental chamber could also serve well, h) perform final inspection three-dimensional imaging, localized spectroscopy, and/or electrical probing with SPM.

In another embodiment, an organic low-K dielectric (e.g., as an interlevel dielectric) may be edited using an etchant such as ozone. In cases where the ILD etch is exothermic, a second channel of the probe 518 can assist in managing the reaction in one of the following ways, by providing a diluting fluid, which would then spread over the space surrounding the reaction site and thereby remove reaction product, excess reactant and/or excess heat, which might otherwise damage nearby areas. Alternatively, the second channel can provide a source of gas to expel reaction product, excess reactant, or to distribute the heat over a larger volume. In another alternative, the second channel can provide suction to carry away effluent from the reaction. Moreover, the diluting fluid, expulsion gas, and/or suction can be used individually or in combination as needed for a particular application during the course of a repair.

Exothermic etching of the ILD can proceed in an arrangement in which the substrate 510 is maintained in a vacuum. As the chemical is delivered to the reaction site through the probe 518, reaction products, and excess reactant are drawn away from the reaction site by the negative pressure gradient at the surface. Alternatively, the substrate 510 can be maintained in a liquid, with a positive pressure applied to the chemical reservoir 530. Reaction products would then be expelled into the surface liquid, which would then dilute them, while distributing the heat, to help spatially confine the reaction to only the actual site where desired.

If copper metal features are also present, the method of this embodiment may further encompass subsequently editing the existing copper feature (by the same probe or by a second probe). In the copper editing, the reaction is preferably confined to a smaller volume, such as by maintaining the energy level supplied by the illuminating source 540 through a light guiding portion of the probe 518 just sufficient to invoke the reaction involving the chemical supplied thereto through channel of the probe 518. When the probe 518 is also provided with a near-field aperture, near-field energy radiating therefrom could be further used to invoke the reaction. When the same probe as used in the ILD etch, is used in the copper etch, the copper etchant can be delivered through a second channel of the probe 518. Since the editing of the copper feature in the second process occurs within a large open volume, any copper redeposited thereby (as a byproduct of the editing process) is distributed in very small amounts over a large area. Consequently, the redeposited copper is much less likely to form deposits which are attached and continuous, such as could cause conductive shorting of exposed metal patterns that are to remain unaffected.

The methods of the invention may be used to edit a copper feature buried below one or more organic low-K dielectric layers. First, using the method described above, an access hole would be etched in the organic low-K dielectric by delivering a chemical such as ozone through probe 518. Then, a different etchant would be delivered by the probe 518 to etch any oxide hard mask layers. For example, to create a reactive species for etching an oxide hard mask, in which the reactive species is hydrofluoric acid, a first channel of the probe can be used to deliver a source of fluorine ions, and a second channel used to deliver a source of hydrogen ions (e.g., water) to complete the acid. Alternatively, if the probe includes channels which are unaffected by hydrofluoric acid, the acid could be delivered through a single channel of the probe.

Once the copper feature is exposed, in the copper edit method described above, the probe (either the same probe or a second probe) can dispense an appropriate etchant for copper, such as a mixture of water/hydrogen peroxide/and sulfuric acid (etchant known as “piranha”).

Following the copper edit, a probe having a channel could be used to refill the etched hole in the IC with an organic dielectric precursor, and the repair then completed, either by heating the entire substrate 510 or just a local region by illumination (such as through a light guide of the probe 510), or even another source, e.g. far-field illumination external to the probe body.

In another embodiment, a system is used to the repair of a transmissive defect in a photomask (a feature of a mask which shifts the phase of the light transmitted there through and/or attenuates the light). Such defects occur in the clear (light transmissive) portions of the mask, rather than in opaque features, e.g. the chrome patterns of a mask having thickness greater than 50 nm. Since the features to be repaired transmit light, alternative beam-based repair systems, which use only an illuminating source which is not confined in the vertical or Z-axis direction, and have no other way to confine the desired reaction, cannot suitably repair the feature on the surface of the mask. A preferred embodiment of a system, as described above relative to FIG. 4 is particularly well adapted to the repair of transmissive defects in masks, because the reaction used in the repair is spatially confined by the extent of chemical distribution delivered by the probe 518.

While the invention has been described herein in accordance with certain preferred embodiments thereof, those skilled in the art will recognize the many modifications and enhancements which can be made without departing from the true scope and spirit of the present invention.

1. A system adapted to alter a feature of a substrate, said system comprising:
(a) a probe having a plurality of channels through said probe to exit at an apex of said probe,
(b) means for maneuvering said apex of said probe to a site proximate to a target feature to be altered, and
(c) a source of a first chemical coupled to a first said channel for delivery of said chemical through said apex, and
(d) a source of at least one of a second chemical, a diluting fluid, an expulsion gas, and suction, coupled to a second channel for delivery though said apex.

2. The system of claim 1 wherein said second channel is coupled to a source of a second chemical, and said second chemical is adapted to mix with said first chemical after exiting said apex to form a reactive species.

3. The system of claim 1 wherein said second channel is coupled to a source of diluting fluid, said diluting fluid adapted to dilute effluent from a reaction at said site to spatially confine an effect of said reaction.

4. The system of claim 1 wherein said second channel is coupled to a source of suction, said suction being adapted to remove effluent from a reaction at said site to spatially confine an effect of said reaction.

5. The system of claim 4 wherein said suction is adapted to remove hot effluent from said reaction.

6. The system of claim 4 wherein said suction is adapted to remove a product of said reaction.

7. The system of claim 1 wherein said channels are arranged parallel to each other in said probe.

8. The system of claim 1 wherein said channels are arranged concentrically to each other in said probe.

9. A method of altering a feature of a substrate, said method comprising:
(a) delivering a chemical for assisting in a reaction to a site proximate to a target feature to be altered through a channel of a probe, said channel having an exit at an apex of said probe; and
(b) providing at least one of a second chemical, a diluting fluid, an expulsion gas, and suction to said site through a second channel of said probe,
wherein said at least one of said second chemical, said diluting fluid, and said expulsion gas aids in at least one of promoting and/or managing said reaction at said site.

10. The method of claim 9 wherein a second chemical is provided through said second channel, such that said second chemical mixes with said first chemical to form a reactive species after exiting said apex.

11. The method of claim 9 wherein a diluting fluid is provided through said second channel, said diluting fluid diluting effluent from a reaction at said site so as to spatially confine an effect of said reaction.

12. The method of claim 9 wherein suction is provided by said second channel, said suction locally removing effluent from a reaction at said site so as to spatially confine an effect of said reaction.

13. The method of claim 12 wherein said suction locally removes hot effluent from said reaction to thereby provide spatial confinement when said reaction is exothermic.

14. The method of claim 12 wherein said suction removes a product of said reaction so as to spatially confine distribution of said product due to said reaction.

15. A method of exothermically etching a very small surface area of an organic dielectric material on a substrate, said method comprising:
(a) delivering a chemical for assisting in an exothermic reaction to a site proximate to a feature comprising organic dielectric on said substrate through a channel of a probe exiting at in an apex of said probe; and
(b) providing at least one of a second chemical, a diluting fluid, an expulsion gas, and suction to said site through a second channel of said probe,
wherein said at least one of said second chemical, diluting fluid, expulsion gas, and suction aids in spatially confining an effect of said exothermic reaction.

16. The method of claim 15 wherein a second chemical is provided through said second channel, such that said second chemical mixes with said first chemical to form a reactive species after exiting said apex.

17. The method of claim 15 wherein a diluting fluid is provided through said second channel, said diluting fluid diluting effluent from said reaction so as to spatially confine an effect of said reaction.

18. The method of claim 15 wherein suction is provided by said second channel, said suction locally removing effluent from said reaction so as to spatially confine an effect of said reaction.

19. The method of claim 15 further comprising illuminating said site with ultraviolet radiation from a light guide proximate to said site.

20. The method of claim 19 wherein said light guide is integral to said probe.
